(19) United States
(12) Patent Application Publication
(10) Pub. No.: US 2015/0032530 A1
(43) Pub. Date: Jan. 29, 2015

(54) CRE & MCPC Software & Website

(71) Applicant: Eric Wilfred Olson, Sayreville, NJ (US)

(72) Inventor: Eric Wilfred Olson, Sayreville, NJ (US)

(21) Appl. No.: 13/739,319

(22) Filed: Jul. 28, 2013

(51) Int. Cl. G06Q 20/34; G06Q 30/02

(52) U.S. Cl. CPC G06Q 20/3574; G06Q 30/0229; G06Q 20/3572
USPC 705/14.28; 705/41

(57) ABSTRACT

My pin driven CRE & MCPC system will consolidate rewards and credit & debit cards of each member into a single high security micro chip personal card that can be used at all vendors where these credit & debit cards are accepted. The CRE & MCPC card will be used as a traditional credit/debit card by inserting it into the card terminal at any vendor that accepts credit/debit card, enter their 5 digit pin; select the card from their account to charged the purchase to (ie: 1=AMEX; 2=VISA; 3=MASTERCARD; 4=DISCOVER and so on for local store credit cards.) This MCPC system will give each member the option to split up the payment of a single purchase with more than one card in their CRE & MCPC account.

Members will also manage other aspect of rewards and credit/debit cards. Bill payment

### CROSS-REFERENCE TO RELATED APPLICATION

Not Applicable

### STATEMENT REGARDING FEDERALLY FUNDED RESEARCH AND DEVELOPMENT

Not Applicable

### REFERENCE OF SEQUENCE LISTING, A TABLE, OR COMPUTER PROGRAM LISTING COMPACT DISC APPENDIX

Not Applicable

### BACKGROUND OF THE INVENTION

Problem Solved: There are many rewards, miles and points membership programs from vendors that are not exchangeable or can be traded, and members cannot manage or control their rewards or points earned.

The problem currently is that almost everyone has some kind of airline reward miles on two or more airlines, but not sufficient to utilize at times. Similarly, with points earned from various vendors. Everyone rewards miles and points are with the various vendors, and the consumers cannot keep accurate track of all, neither can they transfer, interchange, barter, donate nor trade their rewards.

This same problem exists with CREDIT/DEBIT CARDS. There are so many people with at least three or more different type credit and debit cards which also give reward points or cash back when a user uses his/her credit/debit card. What if each user reward can be consolidated into one statement with a value that can be exchanged, traded, donated or bartered? Consumers will more prudently manage the benefits they earned from all these reward points, miles and cash back. Furthermore, one major problem is that each individual has to carry a bulky purse/wallet with the various credit/debit cards and will need to use more than one of their credit/debit cards to pay for a single item if their do not have the available balance on just one of their credit/debit cards.

### BRIEF SUMMARY OF THE INVENTION

My invention will consolidate all our users/members credit/debit cards into one high security micro-chip personal card that can be used at any vendor where credit/debit cards are accepted. Our users/members will only need to use their single CRE/MCPC card (WINICARD) to pay from all or one of their credit/debit cards they have listed in their CRE/MCPC account, because our MCPC system will consolidate their available balances and approve/decline the purchase based upon their consolidated available balance against the cost of the item being purchased. Once the transaction with the merchant is completed our users/members will now have the option to charge the total purchase amount to a single card (default card) on their MCPC account or split/spread the total purchase amount over all or some of their credit/debit cards listed in their CRE/MCPC account. The working of this system is shown in the drawings submitted with this substitute specification.

My invention is new and will solve the problems consumers currently faced by not knowing exactly what rewards they have and how can they effectively use them in a consolidated system as the CRE. Similarly so, credit cards users can make bigger purchases without swiping 3 or more different cards to make a purchase. A pin driven micro chip personal card (with the logo of each credit card company the holder has credit with) will consolidate all the consumer credit/debit cards into this high security micro chip personal card.

### BRIEF DESCRIPTION OF SEVERAL VIEWS OF THE DRAWINGS

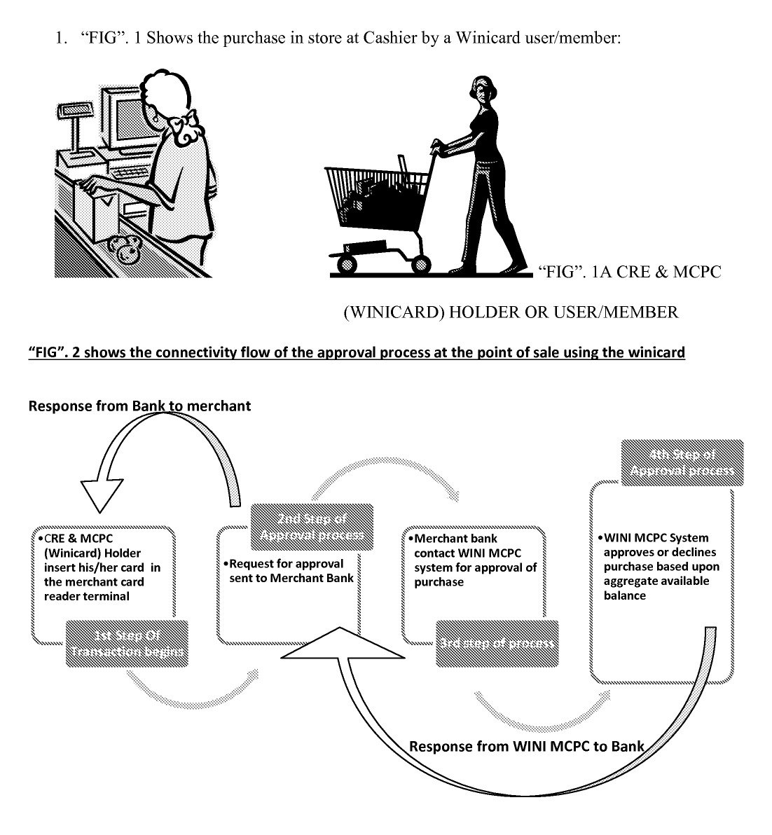

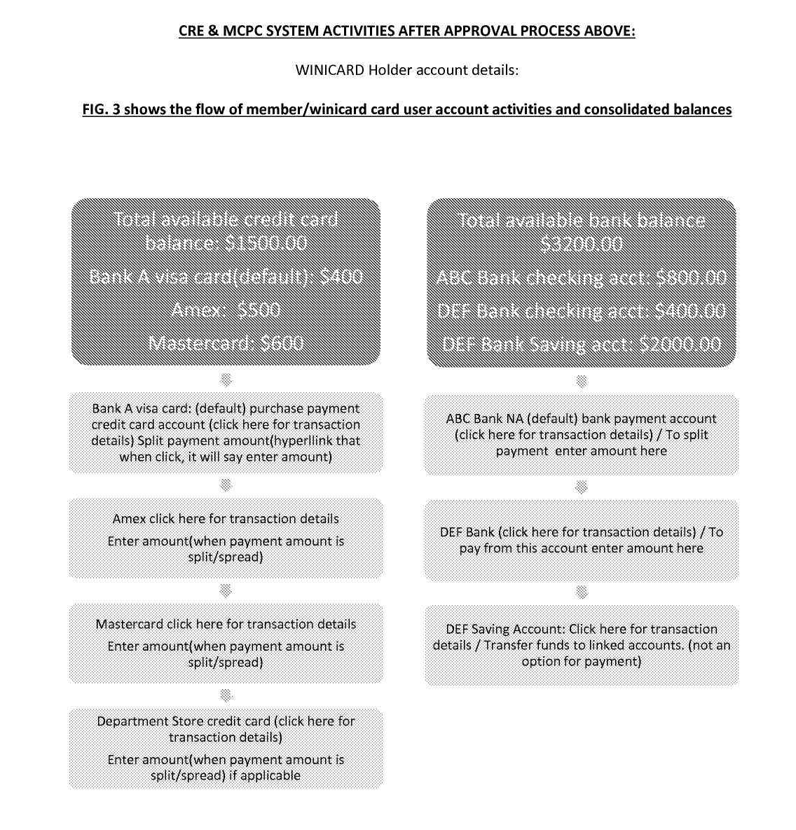

“FIG. 1” and “FIG. 1A” shows the areas of usage and interactions between CRE/MCPC (WINICARD) card holder and the various merchants at the point of sale.

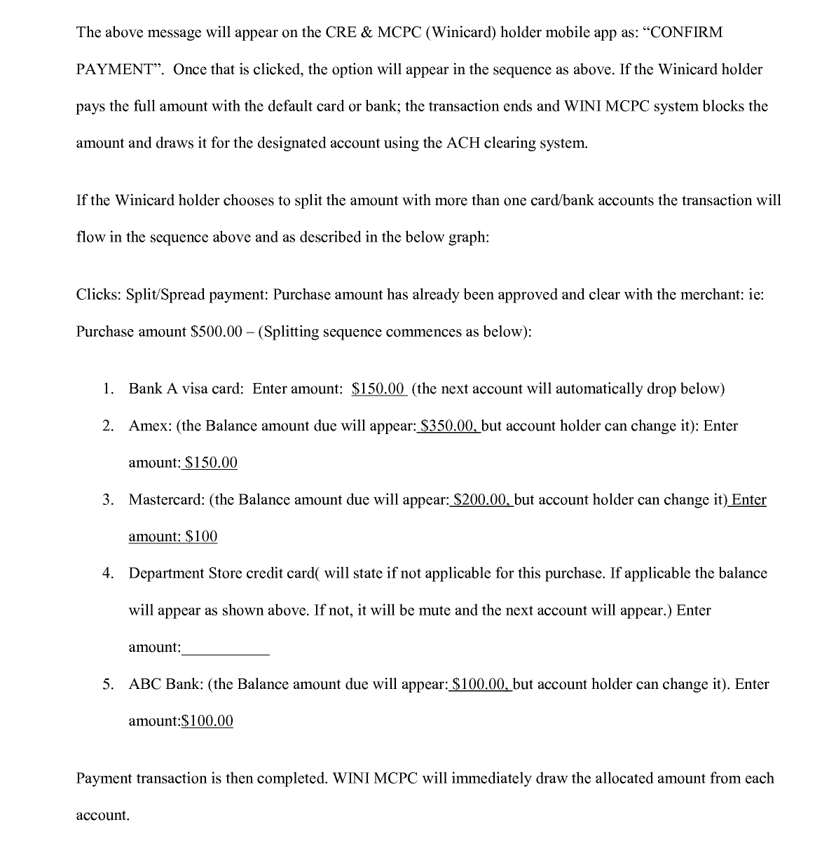

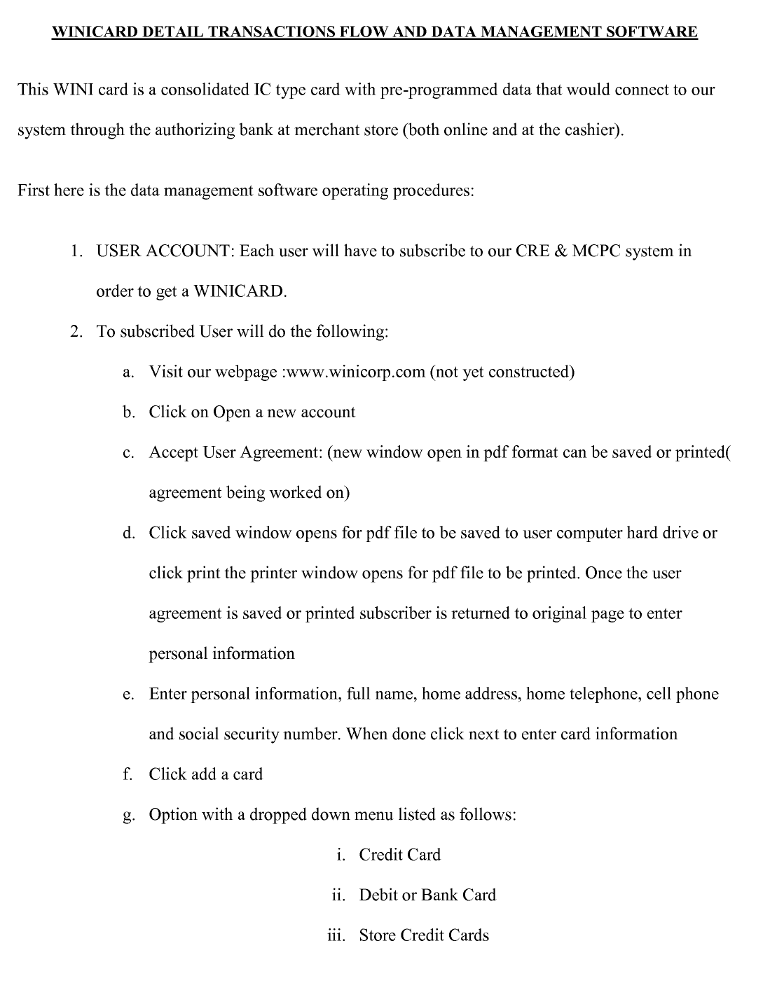

“FIG. 2” details the flow of the approval process at the point of sale when the Winicard is used. In this view, the background activities/approval process when the CRE/MCPC (WINICARD) card holder uses his/her card is explained.

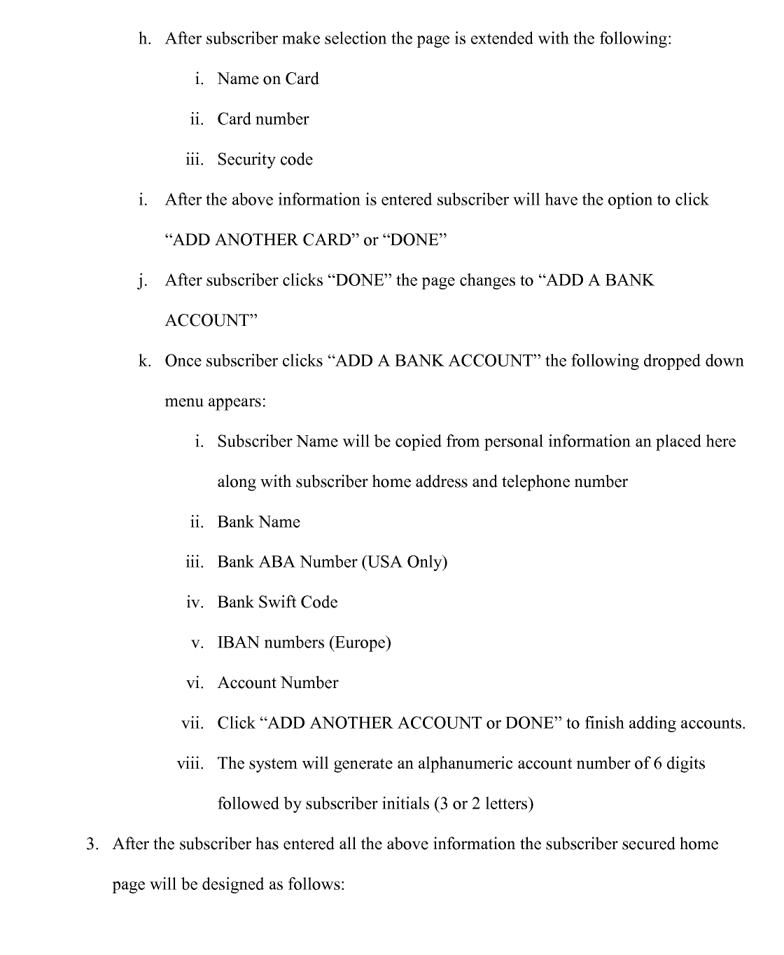

“FIG. 3” shows the Winicard holder/member consolidated account balances and the flow of activities as to how the Winicard consolidated account works when purchases are made using the Winicard. This section shows how the Winicard user is able to split/spread the total purchase price over more than one credit/debit card and bank account after a purchase is made.

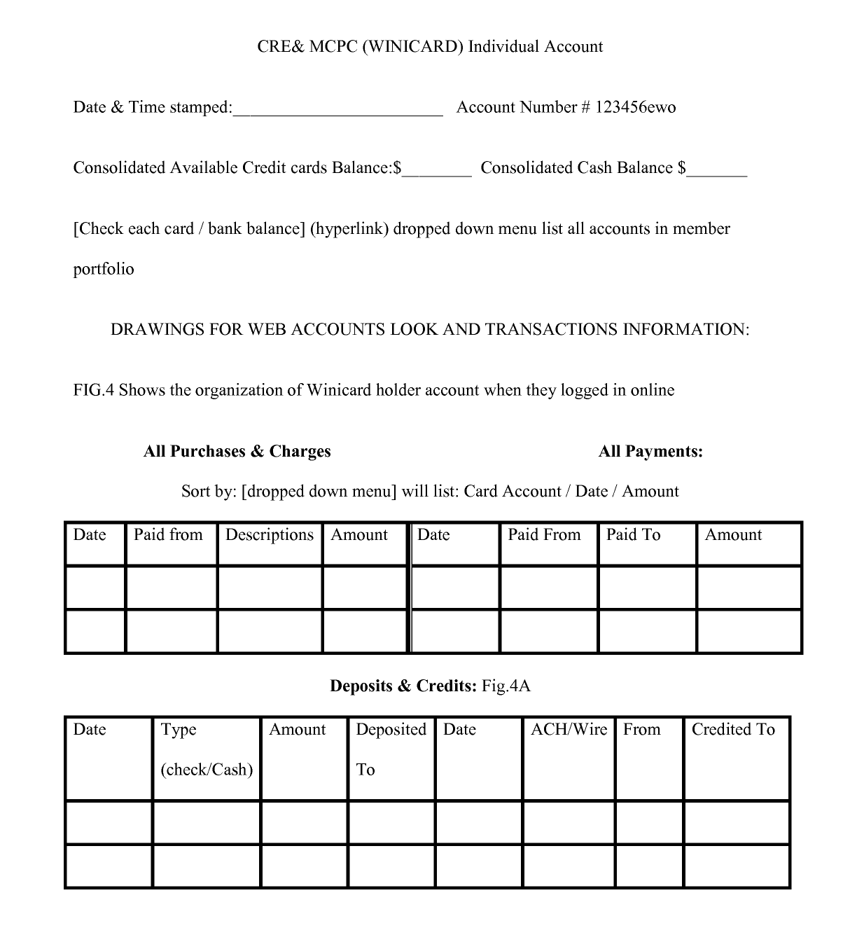

“FIG. 4” and “FIG. 4A” show the web designed page with the information our user/member will have access to in order to manage their account.

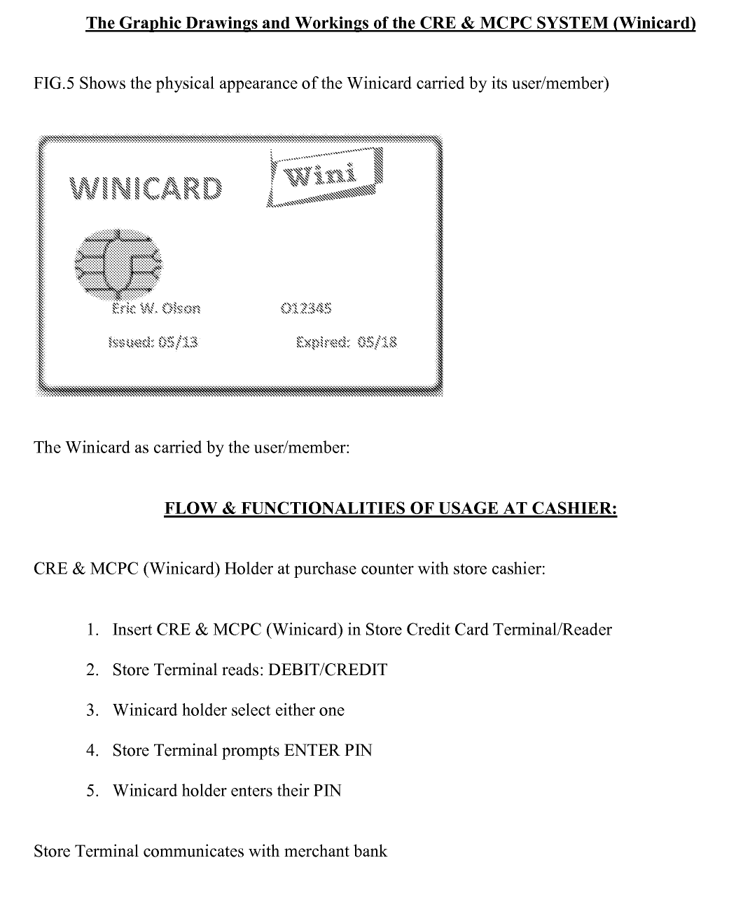

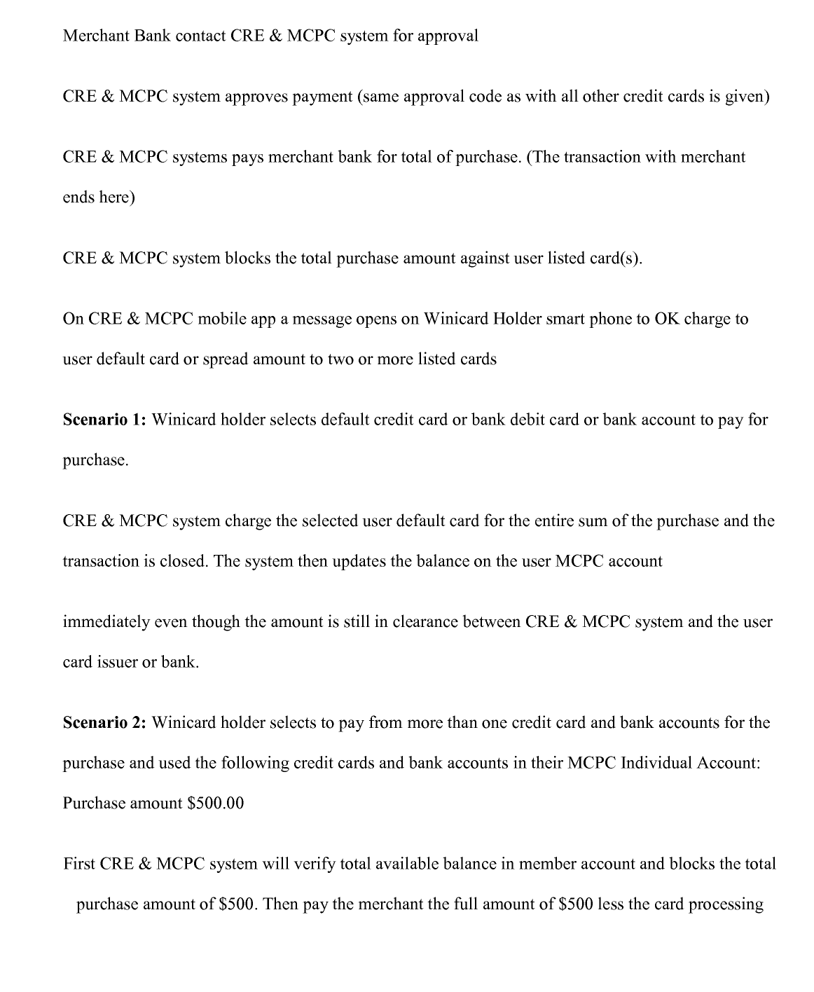

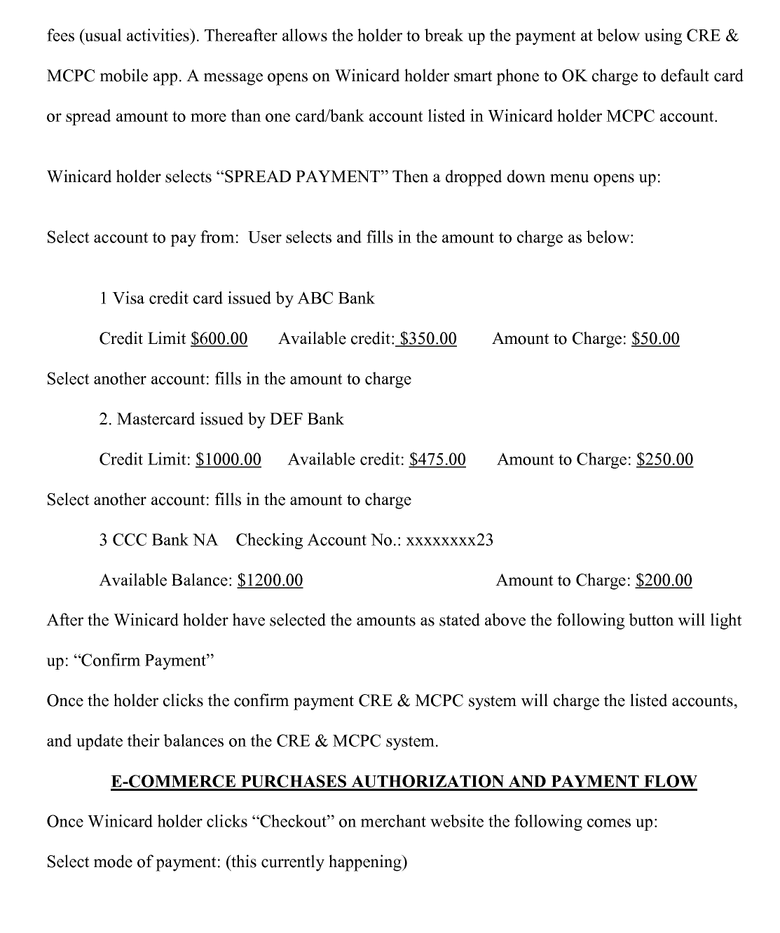

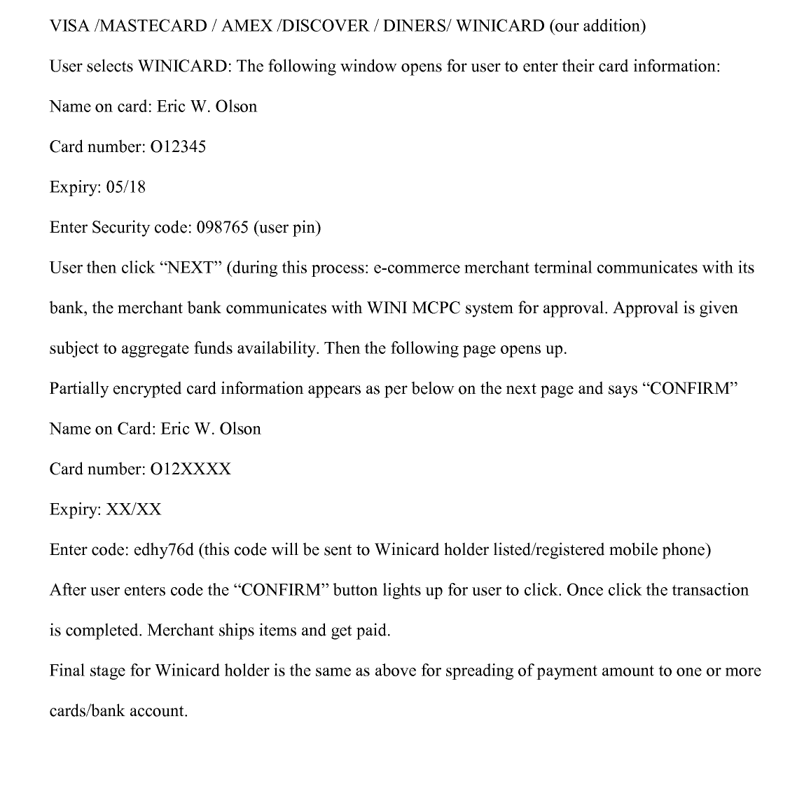

“FIG. 5” shows the prototype of the CRE/MCPC (WINICARD) card that will be issued by our system to users/members.

### DETAILED DESCRIPTION OF INVENTION

There are many rewards, miles and points membership programs from vendors that are not exchangeable or can be traded, and members cannot manage or control their rewards or points earned.

The problem currently is that almost everyone has some kind of airline reward miles on two or more airlines, but not sufficient to utilize at times. Similarly, with points earned. Everyone rewards miles and points are with the various vendors, and the consumers cannot keep accurate track of all, neither can they transfer, interchange, barter, donate nor trade their rewards.

This same problem exists with CREDIT CARDS. There are so many people with at least three different credit cards which also give reward points or cash back when a user uses his/her credit/debit card. What if all reward can be consolidated into one statement with a value that can be exchanged, traded, donated or bartered? Consumers will more prudently manage the benefits they earned from all these reward points, miles and cash back.

My invention is new and will solve the problems consumers currently faced by not knowing exactly what rewards they have and how can they effectively use them in a consolidated system as the CRE. Similarly so, credit cards users can make bigger purchases without swiping 3 or more different cards to make a purchase, and don't have to carry several credit & debit cards on them. My pin driven micro chip personal card (MCPC) (with the logo of each credit card company the holder has credit with) will consolidate all the consumer credit & debit cards into this high security micro chip personal card. That our user can use at all vendor where these credit & debits cards are accepted. User will then insert their MCPC consolidated card into the vendor's machine, enter their 5 digit pin and select which card under their account the charged payment should be charged to. User will also have the options to split payment for a single purchase into more than one credit/debit card listed in their CRE & MCPC (CC) account.

As stated above, there are many rewards, miles and points membership programs from vendors that are not exchangeable nor can be traded, and the beneficiaries do not have the system and program to manage and control their rewards earned from being a loyal customer to these vendors. My invention claimed here solves this problem.

With the Consolidated Rewards Exchange (CRE), members of this program will have full control to trade and exchange their rewards miles, points and/or cash (when applicable) for goods or donate to charity. Members will also be able to barter miles and points in order to obtain the needed miles or points for their specific use/need. Members will no longer carry a reward card for each vendor, but rather a single membership card or a high security micro chip personal card that will enable transactions to be recorded and posted to the CRE member's account under the individual vendor. Members will have unlimited online excess to their account and can sign up for daily changes update to their account via both text and or email.

The claimed invention differs from what currently exists. My invention is not yet known based upon my personal search done thus far. Nevertheless, it will consolidate and allow members to sell, barter, and use the rewards miles and points for their needed purpose. That is, members would be able to use miles earned on one airline and add it to the miles from another airline to purchase a reward ticket on either one of the said airlines. Members also would be able to see all rewards they have earned each month and control its use.

This invention is a vast improvement and immensely different from whatever currently exists. My invention is not yet known based upon my personal search done thus far. This invention will ease the frustration and add value to all users. It will also give the users the opportunity to become more loyal to vendors that give the most rewards. Also with the high security micro chip personal card, the member is able to use this one card to pay any vendor using his/her choice of credit card company account by simply selecting the corresponding number to the desired credit card. (ie: 1=AMEX; 2=VISA; 3=MASTERCARD; 4=DISCOVER and so on for local store credit cards.) Consumers will be able to see up-to-the-minute credit balances before selecting which credit card to pay from.

My invention is new and will solve the problems consumers currently faced by not knowing what rewards they have and how can they effectively use them in a consolidated system such as the Consolidated Rewards and Exchange (CRE).

Also, this invention can be used for consolidating personal data credit/debit cards with applications that make users manage other aspect of credit/debit cards and bill managements. A mobile app would be quite efficient to assist individuals stay on top of the uses, payment, and management of all bills.

### CRE & MCPC (Home Page)

Welcome to Consolidated Rewards Exchange and Microchip Personal Cards security applications. Sign up by clicking the link below.
a. Sign up for Consolidated Rewards Exchange (hyperlink take user to signup page)
b. Sign up for Consolidated Credit Card (MCPC) Account/(hyperlink take user to sign up page)

Advertisement strip (hyperlink take user to advertiser's home page)
a. Cards Offers (hyperlink take user to card issuer offer page)
b. Vendors discount (hyperlink take users to vendor's coupons or discount page)

Account sign up for charitable entities (hyperlink take user to sign up page)
a. Account sign up for vendors (hyperlink take user to sign up page)
b. Rewards/Points/Miles available for trading: All vendor whose rewards/points/miles is been traded will be listed. Click on vendors name will list all available trades

Sign up page for CRE & MCPC
a. enter your name, address, Telephone & email address:
b. Click here for user agreement (user agreement pop up in new window to accept or reject once reject is selected sign up page is terminated)
c. Enter date of birth and social security (encrypted)
d. enter a 5 digit pin
e. select security question and answer
f. Enter rewards cards from each vendor: (enter up to 10 reward cards)
   1. Enter card number
   2. Enter vendor name
   3. Enter vendor address
g. Select card design
h. Click Activate to order you new card. (new window (secured) opens up to payment for enrollment. Credit card details for payment is entered and charged) Card is then ordered for production and mailing.

Sign up for Consolidated Microchip Personal Card
1.) Import data from CRE account. If Yes, all fields filled in with personal info. If No, program terminates
2.) Member to enter all current debit (including prepaid) & credit cards details
   a. Type Card Number Security Code Expiration
   b. MC/V/AMEX/Discover (Type & Expiration date displayed from drop down menu) Card Number and Security Code have separate fields for data entry.
   c. User can enter up to ten different credit and debit cards. Including prepaid cards
   d. select a 5 digit pin
   e. CRE & MCPC system will verify each card entered and assigned it a presorted number (in this order: mc1, V1, AE1, & D1. where MC for Mastercard, V for Visa, AE for American Express & D for discover. Bank debit and store cards will have the 1^{st} two letters of issuer (bank or store) name. The number shown is assign based upon the number of cards you entered from each card issuer) before allowing user to add another card account.
   f. Against each card successfully entered user will be able to click and do the following edit/add/remove
   g. User will then be required to select bank accounts from which payment for credit cards bills can be made in order of preference.
   h. User can now create a user name and password to manage their account from our web application.

### The Program Workings After Enrollment

Online account is established for each user enrolled. Each user can log into their account from our website or smart phone mobile application and see the following:
a. A list of all cards (debits & credits) currently in the account
b. The current available balance for each card listed
c. All charges posted to each card listed
d. All pending charges for each card listed
e. Payment amount and due date for each credit card listed (an automatic text/email reminder for payment due will be sent 2 days before due date)
f. User will be able to pay all credit cards account directly from their CRE & MCPC account (from mobile app a pay all minimum balance button will be enabled to pay from default bank account in order of preference from all bank account listed under user CRE & MCPC (CC) account.
g. User can set a minimum balance notification for each bank account

Online account is established for each user enrolled in the CRE program as well. Each user can log into their account from our website or smart phone mobile application and see the following:
a. A list of all vendors rewards/Points/Miles cards currently in the account
b. User will be able to see the current available rewards balance for each card listed
c. All rewards/points/miles earned and used will be posted to each card listed
d. Against each rewards, points, or miles user will be able to: REDEEM/TRADE/DONATE
e. When user clicks “REDEEM” another window pops up from which the user can select the account from which the reward/point/miles is been redeemed.
f. When user have selected the vendor, the list of items that can be redeemed by the available rewards/points/miles will be highlighted on the top of the page. All other items available for redemption and the required rewards/points/miles will be listed against each item. (this information will be downloaded directly from the vendors website.
g. When user clicks “TRADE” another windows pops up that allows user to select the vendor that issued the rewards/points/miles and next to it, post the amount of their rewards/points/miles they want to trade. In this same window user can select the following options from the dropped down menu: This dropped down menu will show: 1. Sell for CASH 2. Barter. When “2. Barter” is selected the next dropped down menu appears next to it and list of all available vendors rewards/points/miles available for bartering. Once the desire vendor is selected then the “Submit Trade Button” activates for user to click.

Once clicked, the trade is posted to our trading platform where all registered user can view from their account and buy for cash or barter.

When the user selected “DONATE” a dropped down menu with a list of all registered Charities appears.

User can select the registered Charity of their choice. Then “DONATE NOW” button activates. Once clicked, the user account is reduced by the donated rewards/points/miles and the registered beneficiary charity account is then increased by the donation amount. Registered charities can redeem all donations by the process stated in “e” above

### Usages of CRE & MCPC (CC) Card

Each enrolled user will be able to use their CRE & MCPC card at every vendor that accepts credit/debit cards. Rather than swiping card, the user will:
a. Insert their card into the card reader machine. Our system will then recognize the vendor
b. And a screen will appear for the user to enter his/her 5 digit pin. Once the pin entered has been validated,
c. the user will then have access to chose which credit/debit account to use for payment.
d. The user can split the payment up by entering an amount next to each of their listed credit/debit cards.
e. Payment is approved based on available balance and transaction is completed

All credit and debit cards number and details will be programmed in the MCPC chip. Only user name will appear on MCPC card with the issued and expiry date. The top of the card will read “WINI Consolidated Card” and have the logo of each credit card processing company on it including other store credit facility. Ie: AMEX, VISA, MC, Discover, etc
f. Registered user will also be able to deposit funds on the MCPC card and withdraw from any ATM free of charge.

1. My CRE invention will consolidate individual rewards and allow holders of vendor rewards to monitor, trade, redeem and donate their rewards through our patented software. My invention is new and will solve the problems consumers currently faced by not knowing what rewards they have and how can they effectively use them in a consolidated system such as the Consolidated Rewards and Exchange (CRE) web-based Software.

2. My MCPC invention will also consolidate each registered user various credit and debit cards into a single Personal identification Number (PIN) accessible micro-chip personal card. The MCPC card will contain all the details of all the credit and debit cards the registered user added to our consolidated system, and the registered will be able to use this single card to pay for their purchases by selecting one or more of their credit or debit cards and the desire amount from each card after the time of payment.

3. The MCPC will also allow registered user to deposit funds into their debit cards account by inserting their MCPC card (WINICARD) into the credit/debit card machine where the transaction is been processed.

4. Also with the high security micro chip personal card, the member is able to use this one card to pay any vendor using his/her choice of credit card company account by simply selecting the corresponding number to the desired credit card. (ie: 1=AMEX; 2=VISA; 3=MASTERCARD; 4=DISCOVER and so on for local store credit cards.)

5. Consumers will be able to see up-to-the-minute credit balances before selecting which credit card to pay from.

6. Also, this invention can be used for consolidating personal data credit/debit cards with applications that make users manage other aspect of credit/debit cards and bill managements.

7. A mobile application would be quite efficient and effective to assist individuals stay on top of the uses, payment, and management of all bills and splitting/spreading a single purchase over two or more listed credit/debit cards.

8. Registered users are protected if their cards get missing/stolen because the MCPC is a programmable PIN accessible card and its card number cannot be used for any transaction over the internet or phone. To use at an ATM or other card machine, the PIN is required.
